(19) United States
(12) Patent Application Publication
(10) Pub. No.: US 2016/0134913 A1
(43) Pub. Date: May 12, 2016

(54) DISPLAY DEVICE AND CONTENT VIEWING SYSTEM

(71) Applicant: HITACHI MAXELL, LTD., Osaka (JP)

(72) Inventor: Tsuguo ITAGAKI, Kanagawa (JP)

(21) Appl. No.: 14/897,215

(22) PCT Filed: May 27, 2014
(86) PCT No.: PCT/JP2014/063911

§ 371 Date: Dec. 9, 2015

(30) Foreign Application Priority Data
Jun. 10, 2013 (JP) 2013-121416

(51) Int. Cl. H04N 21/258; H04N 21/482; H04N 21/475; H04N 21/441; H04N 21/254; H04N 21/658

(52) U.S. Cl. CPC H04N 21/25875; H04N 21/2541; H04N 21/6581; H04N 21/4753; H04N 21/441; H04N 21/482

(57) ABSTRACT

A display device which can be safely and simply operated while protecting privacy of each user is provided. The present display device is a display device which can communicate with a content distribution device through network, and includes: a user authenticating unit which manages accounts of a plurality of users and which creates user authentication information containing at least one of the plurality of accounts to be authenticated by the content distribution device; a communicating unit which transmits the user authentication information and content selection information to the content distribution device and which receives content information from the content distribution device, the content information containing content identification information by which a content specified based on the account contained in the user authentication information can be uniquely identified; a display unit which displays the content information received by the communicating unit; and a selection operating unit which selects at least one content based on the content information and which creates the content selection information based on the content identification information of the selected content.

### TECHNICAL FIELD

The present invention relates to a display device and a content viewing system.

### BACKGROUND ART

As a background art in the present technical field, Japanese Patent Application Laid-Open Publication No. 2009-260712 (Patent Document 1) is cited. The publication document describes that “an authorized person grants a permission to an operator for whom execution of a predetermined operation is limited by a simple operation so that the operator can execute the limited operation”.

### PRIOR ART DOCUMENT

### Patent Document

Patent Document 1: Japanese Patent Application Laid-Open Publication No. 2009-260712

### SUMMARY OF THE INVENTION

### Problems to be Solved by the Invention

In the Patent Document 1, convenience of the technique is not sufficient for the user in accordance with various use environments and use situations. For example, in the Patent Document 1, the authorized person grants a permission to an operator for whom an operation is limited. For example, a case of viewing of moving-picture distribution (video-on-demand) program by connecting a television receiver to a network has such inconvenience that a purchased paid content for children cannot be easily viewed in absence of the authorized person (for example, parent).

### Means for Solving the Problems

In order to solve the problem described above, configurations described in, for example, Claims may be adopted. For example, as described in Claims, a display device which can communicate with a content distribution device through a network can be achieved by providing a display device having a feature including: a user authenticating unit that manages accounts of a plurality of users and creates user authentication information containing at least one of the plurality of accounts to be authenticated by the content distribution device; a communication unit that transmits the user authentication information and content selection information to the content distribution device and receives content information from the content distribution device, the content information containing content identification information by which a content specified based on the account contained in the user authentication information can be uniquely identified; a display unit that displays the content information received by the communication unit; and a selection operation unit that selects at least one content based on the content information and creates the content selection information based on the content identification information of the selected content.

### Effects of the Invention

According to the present invention, a more-convenient display device can be provided.

### BRIEF DESCRIPTIONS OF THE DRAWINGS

FIG. 1(a) is a block diagram illustrating an example of a system configuration;

FIG. 1(b) is a block diagram illustrating an example of a configuration of a television receiver;

FIG. 1(c) is a block diagram illustrating an example of a configuration of a content distribution server;

FIG. 2(a) is an example of an internal configuration of a storage and a memory of the television receiver;

FIG. 2(b) is an example of an internal configuration of a storage and a memory of the content distribution server;

FIG. 3(a) is a data table illustrating a content example of user management information which is managed by the content distribution server;

FIG. 3(b) is a data table illustrating an exemplary content of apparatus information which is managed by the content distribution server;

FIG. 3(c) is a data table illustrating a content example of an attribute relation of an account which is managed by the content distribution server;

FIG. 3(d) is a data table illustrating a content example of an account certificate;

FIG. 4 is a diagram illustrating an example of an operation sequence at the time of initial setting according to a first embodiment;

FIG. 5 is a display example of a menu screen of the television receiver;

FIG. 6 is a display example of a user information setting screen;

FIG. 7 is a display example of a secondary account share/limitation setting screen;

FIG. 8 is a diagram illustrating an example of an operation sequence according to the first embodiment;

FIG. 9 is a display example of a content list display screen based on content list (1) information;

FIG. 10 is a display example of a content detail display screen based on the content list (1) information;

FIG. 11 is a display example of a content list display screen based on content list (2) information;

FIG. 12 is a display example of a content detail display screen based on the content list (2) information;

FIG. 13 is a diagram illustrating an example of an operation sequence at the time of initial setting according to a second embodiment;

FIG. 14 is a display example of an account certificate acquisition screen;

FIG. 15 is a diagram illustrating an example of an operation sequence according to the second embodiment; and

FIG. 16 is a display example of a content list display screen based on content list (2) information.

### DETAILED DESCRIPTION OF PREFERRED EMBODIMENTS

Hereinafter, embodiments of the present invention will be described with reference to the drawings.

### First Embodiment

Hereinafter, a first embodiment according to the present invention will be described with reference to the drawings. In the present embodiment, the description will be made while exemplifying a case of use of a service (hereinafter, referred to as an IPTV service) which distributes a content such as video, audio, and text information through the Internet. However, the present invention is not limited to the present example.

The IPTV service is roughly classified into three services of streaming, downloading, and progressive downloading based on a form. In the streaming, the content data is sequentially distributed from a server to a client, and the content is provided to a user by reproducing the video, the audio, and others from the data received in the client. Therefore, a case of presence of a network having a sufficient broad band has such a feature that the user can view the content in almost real time.

In the downloading, the client previously acquires and accumulates all pieces of the content data from the server, and reproduces the content data for the viewing after completion of the accumulation. Therefore, a case without a requirement to view the content data in real time has such a feature that the user can view the content data many times at a desired timing by previous distribution completion and accumulation of all pieces of the content data so that the content can be distributed even not in the network having the sufficient broad band.

In addition, the progressive downloading is a middle manner between the two services, and the content data accumulated in a terminal is sequentially viewed before all the contents are completely distributed. In this manner, it is not always required to wait for the completion of the accumulation, time taken for the accumulation can be shortened even in a case of not the sufficient broad band, and the service can provide a merit on that the user can view the content many times at a desired timing after the completion of the accumulation.

A content distribution service including the IPTV service charges a fee by a service provider as a price required for receiving the distribution service by the user. At this time, the user is previously registered as a regular user, various types of information such as a password (or biological information such as a fingerprint), a name, and an address are managed from a hint of an identifier (ID).

In a case of distribution the charged content, charging information in the accumulation and the viewing can be recorded, and it is checked that the use fee can be paid by a payment method which is separately designated. At the stage of using the distribution service, it is required that a user authentication for allowing the user to use the service is accepted through verification with the management information based on the identifier (ID) and the password of the registered information. To the authenticated regular user, a content view portal screen for selecting or searching contents to be distributed and for selecting services of other information distribution is provided often.

In addition, a device authentication through communication is performed before the distribution service often, the device authentication checking whether or not a device used by the user is a device recommended by the service provider, or whether or not a program for receiving the distribution service operated in the device is a recommended program. This manner prevents actions that violate the law of the Copyright Act such as data copy, movement, or edit without permission and unauthorized use of the content.

At this time, the content is previously encrypted by a common key encryption system in advance, and a key for decrypting the encryption is stored in association with a separately-received content so as to be decrypted only by the authenticated regular user, to be decrypted only in an authenticated regular connection device, or to be decrypted only in a regular connection device for which the regular user is authenticated. In addition, a public key and a private key may be prepared on the connection device side or the service provider by using a public key encryption system, and the private key may be transmitted to the connection device at the time of registering the user, so that the keys may be used for the encryption and the decryption in each of the service provider and the connection device. Generally, these keys for the decryption are recorded together with a validated date and the number of times for reproducing the content, and a reproduction condition such as a user, a device, or others who/which is allowed for the reproduction. Hereinafter, the key for the encryption will be referred to as encryption key, and the key for the decryption will be referred to as decryption key.

As described above, in association among the user authentication, the device authentication, and the decryption key, the service provider of the IPTV service safely provides the content distribution service or others to the user, and exactly charges the fee as substitute acting for a provider of the content and the service. Then, the user receives the distribution of a desired content, and correctly receives services such as content reproduction. Furthermore, based on these manners, the user can store a content corresponded to and associated with a reproducible right based on the copyright in some cases.

While the user reproduces the content in a predetermined device by using the obtained content and decryption key as described above, the reproduction is made generally based on the same device and the same user. On the other hand, when the same user has a plurality of devices and desires to reproduce the same content in other devices, this case has such inconvenience that the same content is charged again. Therefore, there is a service for allowing the user to reproduce the content in a plurality of devices within a range of the number of devices allowed by the service provider as long as the user is the same user having the reproducible right.

In addition, as similar to the content, there is a service for using a function of an application software by download purchase of the application software and operation of the application software on the device side. Furthermore, as similar to the case of the content, for the authenticated regular user, there is a service for allowing the user to download an application in a plurality of devices within a range of the number of devices allowed by the service provider as long as the user is the same user having a downloadable right.

[System Configuration]

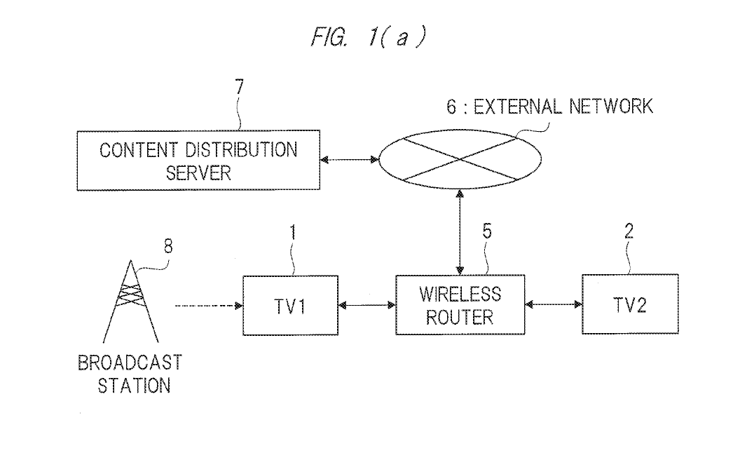

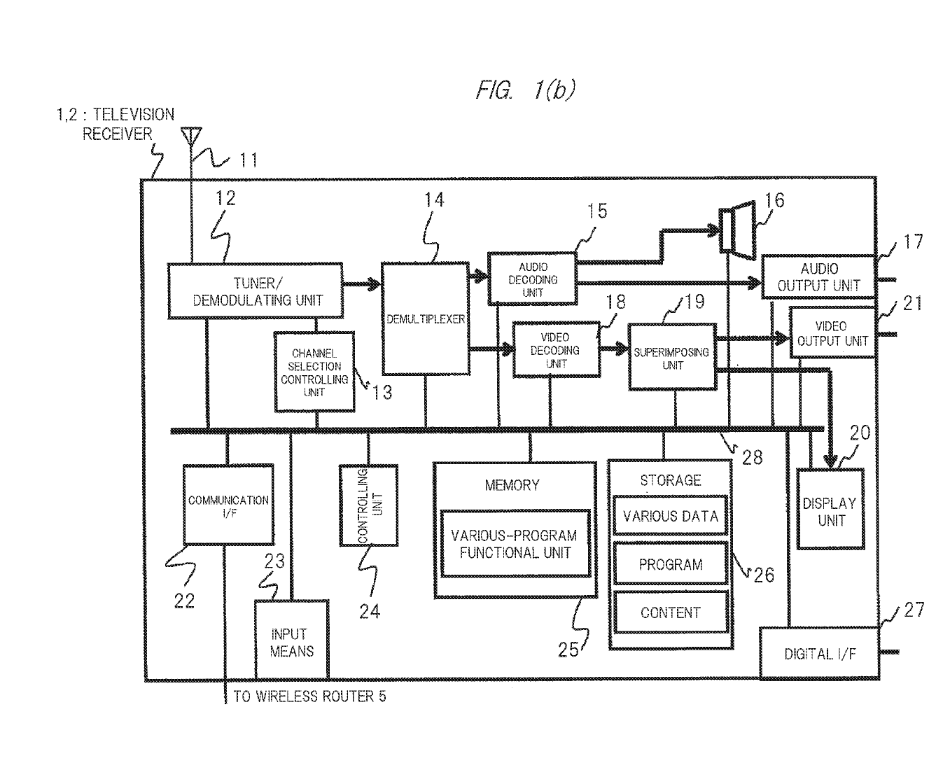

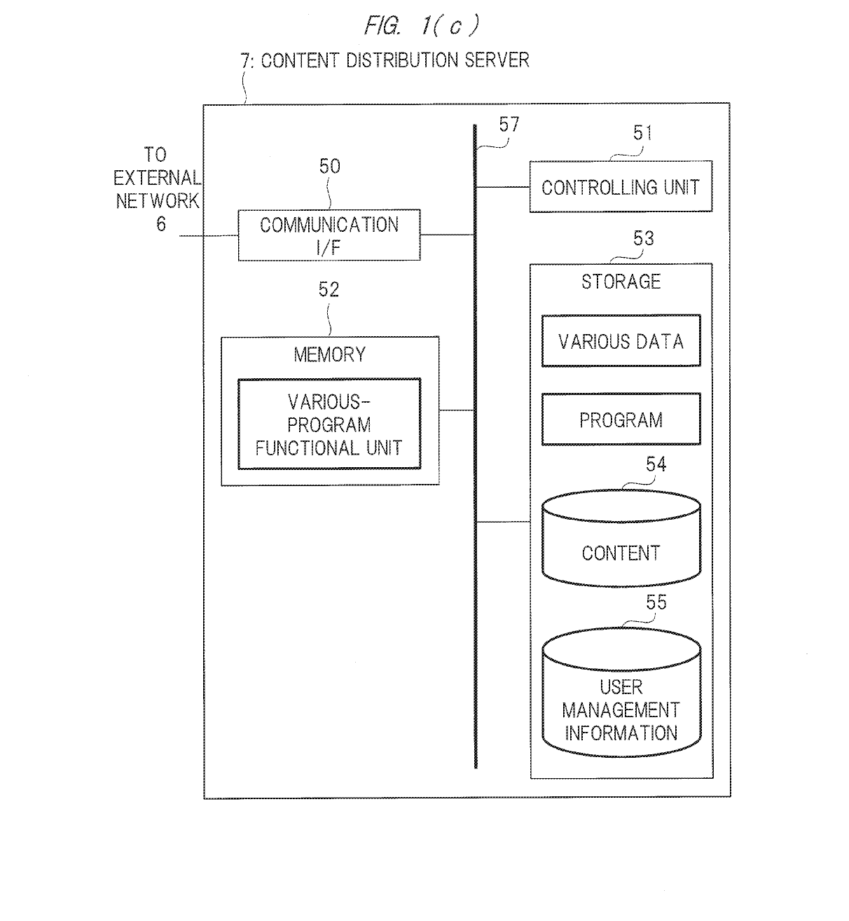

FIG. 1(a) is a block diagram illustrating an example of a network terminal system according to the first embodiment.

The network terminal system of the present embodiment is configured by, for example, a television receiver 1, a television receiver 2, a wireless router 5, an external network 6, and a content distribution server 7. The illustrated example is an example in a case of viewing of a moving-picture distribution program through the connection of the network in the television receiver 1 or the television receiver 2 at a home, a store, or others.

The wireless router 5 is provided with a wireless LAN function such as Wi-Fi (registered trademark), and can access the external network 6 through a communication line. In addition, the wireless router 5 is connected to the television receiver 1 and the television receiver 2 through a wired LAN or a wireless LAN, and the television receiver 1 or the television receiver 2 can acquire information from the Internet through the wireless router 5.

Here, the Wi-Fi (registered trademark) is a standard of the wireless LAN (Local Area Network) established in the standard “IEEE 802.11a/IEEE 802.11b” of IEEE (Institute of Electrical and Electronics Engineers).

The content distribution server 7 accumulates the content such as video and audio, and distributes the content in response to a request from the television receiver 1 or the television receiver 2 connected to the network. The content distribution server 7 is connected to the external network 6, and the television receiver 1 or the television receiver 2 can transmit/receive information to/from the content distribution server 7 connected to the external network 6 through the wireless router 5, or can receive a content and information on the content such as a key for decrypting the encrypted content.

Hereinafter, the first embodiment according to the present invention will be described with reference to the drawings.

[Hardware Configuration of Television Receiver]

FIG. 1(b) is an example of a configuration diagram of the television receiver 1. Note that a configuration of each parts of the television receiver 2 is the same as that of the television receiver 1, and therefore, the description thereof will be omitted. For example, the television receiver 1 is connected to an antenna 11, and includes a tuner/demodulating unit 12, a channel selection controlling unit 13, a demultiplexer 14, an audio decoding unit 15, a speaker 16, an audio output unit 17, a video decoding unit 18, a superimposing unit 19, a display unit 20, a video output unit 21, a communication I/F 22, input means 23, a controlling unit 24, a memory 25, a storage 26, and others, so that the processing units thereof are connected to one another through a bus 28.

Various types of operational functions of the television receiver 1 are achieved by application programs. The application programs are stored in the storage 26, the controlling unit 24 develops the programs from the storage 26 into the memory 25, and the controlling unit 24 executes the programs, so that the various functions are achieved. In the following explanation, for simplicity, the various functions achieved by execution of each program by the controlling unit 24 will be described to be mainly achieved by a “various-program functional unit” developed in the memory 25.

The application programs may be previously stored in the storage 26 at the time of shipping the television receiver 1, or may be stored in an optical device such as CD (Compact Disk)/DVD (Digital Versatile Disk) or a medium such as a semiconductor memory and then installed in the television receiver 1 through a medium connection unit not illustrated. In addition, the application programs can be downloaded from the external network 6 through the communication I/F 22 and the wireless router 5 and then installed. Note that various functions executed by the application programs can be achieved also by using a hardware as processing units having the same functions. When the application programs are achieved as the hardware, the respective processing units mainly achieve the respective functions.

The input means 23 is an input device which receives an input operation from the user to the television receiver 1, and corresponds to, for example, a remote controller, a keyboard, and a pointing device such as a mouse.

The controlling unit 24 receives an input operation of the user through the input means 23, and controls each processing unit such as the channel selection controlling unit 13, the demultiplexer 14, the superimposing unit 19, the memory 25 (the various-program functional unit), the storage 26, and the communication I/F 22.

The tuner/demodulating unit 12 is controlled by the channel selection controlling unit 13, and is tuned to a channel of a desired service. The tuner/demodulating unit selects a desired digital broadcasting signal received from a broadcasting station 8 through the antenna 11, demodulates the broadcasting signal, and generates a transport stream.

The channel selection controlling unit 13 receives a command to select a channel for the service through the input means 23, and controls the tuner/demodulating unit 12 so that the channels to be selected are switched. In addition, in response to the command from the various-program functional unit, the channel selection controlling unit 13 controls the tuner/demodulating unit 12 so that the channel is switched to a service (channel number) at which the event (program) is currently broadcasting and to a showing unit of the broadcasting to which the service belongs.

The communication I/F 22 is connected to the wireless router 5 through the wired LAN or the wireless LAN. The communication I/F 22 can transmit/receive various types of information also to/from a device connected to the external network 6 through the wireless router 5. For example, from the content distribution server 7 connected to the external network 6 or others, a content stream (video/audio stream) can be received in a form such as IP broadcasting or video on demand. In addition, from the content distribution server 7 connected to the external network 6 or others, the video stream and the application programs can be downloaded. The downloaded data or information is stored in, for example, the storage 26. Also, in addition to or in place of the function of the communication to/from the wireless router 5, direct communication to/from an external device not through the wireless router 5 may be configured by a method such as the wired LAN such as the Wi-Fi (registered trademark)), the IrDA (registered trademark), the Bluetooth (registered trademark), and an NFC (Near Field Communication). The communication I/F 22 may be achieved by mounting chips for performing different communication methods. In addition, it may be achieved by mounting one chip for handling the plurality of communication methods. The following is explanation about an example of transmission/reception of various types of information by the communication I/F 22 to/from the content distribution server 7 connected to the external network 6 through the wireless router 5. However, the various types of information may be directly transmitted/received not through the wireless router 5 as described above.

The demultiplexer 14 separates the transport stream obtained by the tuner/demodulating unit 12 and the stream of the content obtained through the communication I/F 22 for each of types such as video data, audio data, subtitle text data, and program information. In addition, the demultiplexer has a function of acquiring the program information (for example, program arrangement information (SI)) and transmitting the program information to other processing block. In addition, when data transmission is requested from the other processing unit, the demultiplexer transmits the designated data to the request source.

The audio decoding unit 15 decodes the audio data separated by the demultiplexer 14. The audio information decoded by the audio decoding unit 15 is outputted from the speaker 16. The audio information decoded by the audio decoding unit 15 may be outputted from the audio output unit 17 to an external device.

The video decoding unit 18 decodes the video data separated by the demultiplexer 14. The video information decoded by the video decoding unit 18 is transmitted to the superimposing unit 19.

The superimposing unit 19 superimposes the decoded video information transmitted from the video decoding unit 18 with an EPG image or OSD image created by the various-program functional unit or an image generated from various types of information (subtitle information, superimposed subtitle, data in the data broadcasting, etc.) separated by the demultiplexer 14. In addition, the superimposing unit 19 synthesizes the video signal with a browser display screen created by a browser engine 2101 described below, or switches and selects the video signal or the browser display screen. The video information passing through the superimposing unit 19 is displayed in the display unit 20.

The display unit 20 is configured by, for example, a display or a liquid crystal panel of a television or a personal computer or others, and displays a UI used for the broadcasted or distributed video and various operations, a Web browser, and images stored in the storage 26. In addition, the video information passing through the superimposing unit 19 may be outputted from the video output unit 21 to an external device. The displaying image/video may be an image generated by the application programs, image/video of the content received through the tuner/demodulating unit 12, or image/video received from the server on the external network 6 through the communication I/F 22.

In addition, a digital I/F 27 which separates the transport stream of a predetermined program by the demultiplexer 14 and which outputs the video and the audio without being decoded may be provided.

The storage 26 stores the application programs and various types of information created by the application programs. In addition, the storage may store the content such as the video/audio stream from the signal received by the tuner/demodulating unit 12 and the communication I/F 22. In the memory 25, the functional units of the application programs stored in the storage 26 are developed by the control of the controlling unit 24.

The image and the video displayed by the display unit 20 may be any of the image generated by the application program, the image and the video of the content received through the tuner/demodulating unit 12, the image and the video received from the content distribution server 7 on the external network 6 through the communication I/F 22.

In addition, in the present embodiment, the example of use of the television receiver has been explained. However, the present embodiment can be also achieved by providing the same video/audio to the television receiver, the display, and the speaker connected to the outside by using a recorder having no display unit or speaker. In addition, in the present embodiment, the symbol “1” has been explained as the television receiver. However, this can be replaced with a STB (set-top box) or a recorder. In this case, the speaker 16 and the display unit 20 can be eliminated from the configuration of the television receiver of FIG. 1(b).

In addition, the present embodiment can be also achieved by a PC, a monitor device, a tablet terminal, or others having the above-described communication I/F. In this case, the antenna 11, the tuner/demodulating unit 12, the channel selection controlling unit 13, and the demultiplexer 14 can be eliminated from the television receiver of FIG. 1(b).

[Hardware Configuration of Server]

FIG. 1(c) is an example of a configuration diagram of the content distribution server 7. The content distribution server 7 is configured by, for example, a communication I/F 50, a controlling unit 51, a memory 52, and a storage 53, and the respective processing units are connected to one another through a bus 57.

The content distribution server 7 stores the application programs in the storage 53, the controlling unit 51 develops the program from the storage 53 into the memory 52, and the controlling unit 51 executes the program, so that various functions can be achieved. For simplicity in the following explanation, the following explanation will be made on an assumption that the various functions achieved by the respective application programs executed by the controlling unit 51 are achieved mainly by the “various-program functional unit” developed in the memory 52.

The communication I/F 50 is connected to the external network 6, connected to the wireless router 5 through the external network 6, and transmits/receives the various types of information to/from the communication I/F 22 of the television receiver 1 or the television receiver 2.

The controlling unit 51 controls the communication I/F 50, the memory 52 (the various-program functional unit), and the storage 53. In addition, the controlling unit 51 has a function of transfer the contents accumulated in a content 54 of the storage 53 to the television receiver 1 or the television receiver 2 through the communication I/F 50 and the external network 6.

The storage 53 stores the application programs and various types of information created by the application programs. In addition, the storage also has a function of accumulating the content, device authentication information, user authentication information, and others in a user management information 55. In the memory 52, the functional units of the application programs stored in the storage 53 are developed by the control of the controlling unit 51.

[Software Configuration of Television Receiver]

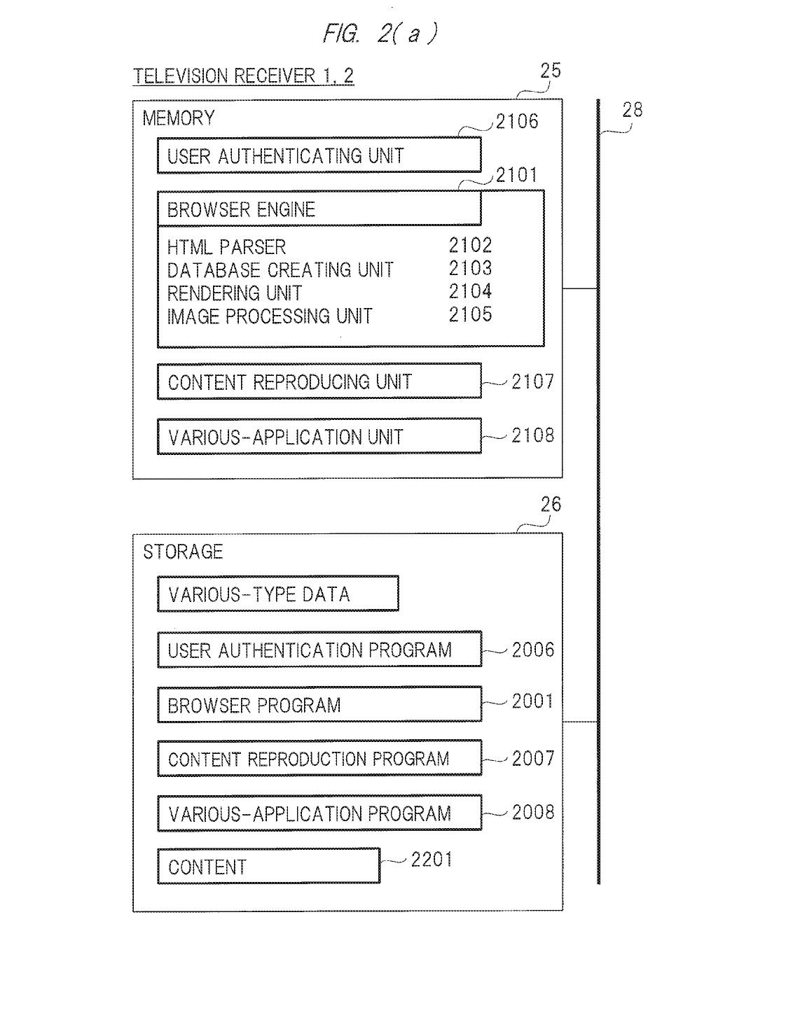

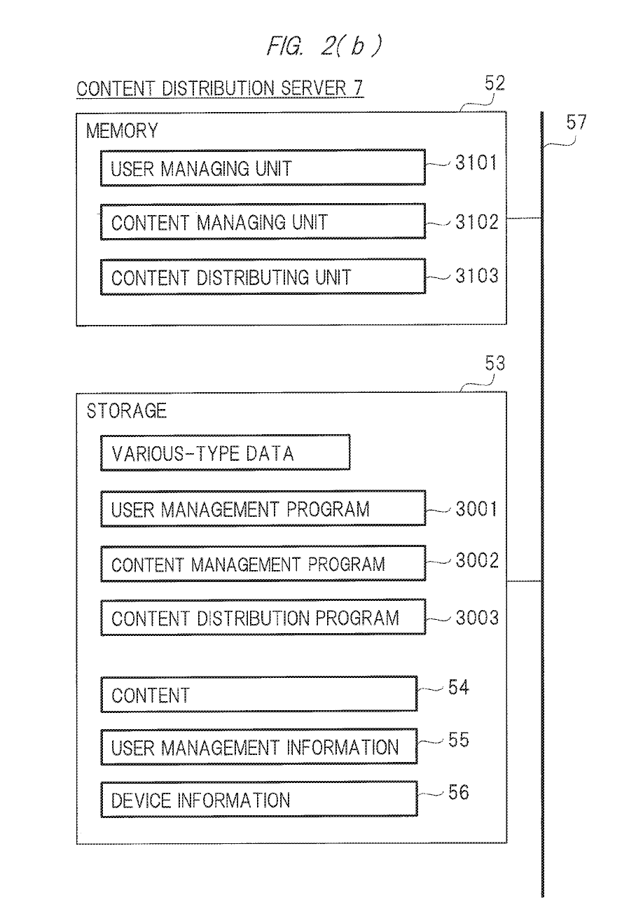

FIG. 2(a) is a diagram illustrating configurations of the memory 25 and the storage 26 of the configuration of the television receiver 1 or the television receiver 2 in FIG. 1(b). In FIG. 2(a), the storage 26 stores a browser program 2001, a user authentication program 2006, a content reproduction program 2007, and a various-application program 2008. These programs are developed in the memory 25 by the controlling unit 24, and the controlling unit 24 executes the programs, so that the functions as the browser engine 2101, a user authenticating unit 2106, a content reproduction unit 2107, and a various-application unit 2108 are achieved. The browser program 2001, the user authentication program 2006, the content reproduction program 2007, and the various-application program 2008 may be stored in the storage 26 at the time of shipping, or may be downloaded through the communication I/F 22. The controlling unit 24 executes these programs to achieve the various functions. However, in order to facilitate the explanation in the following explanation, the respective functional units in the memory 25 will be explained as mainly achieving the various functions.

The browser engine 2101 is configured by various functional blocks of a HTML parser 2102, a database creating unit 2103, a rendering unit 2104, and an image processing unit 2105. The HTML parser 2102 analyzes a logical structure of HTML data acquired through the controlling unit 24. In addition, the acquired HTML data can be interpreted, and can be converted into internal data used in the television receiver 1. The database creating unit 2103 generates a database related to the structure of the HTML data. The rendering unit 2104 generates a layout structure which includes information in an expression format determined by each tag based on the database, and generates the browser display screen in accordance with the data loading a size, a position, and an image based on the layout structure. The image processing unit 2105 converts the acquired image file into image data in a bitmap format based on image file information such as an arrangement of the image file and a name of the image file designated by the image tag in the HTML data.

In order to be authenticated by the content distribution server 7, the user authenticating unit 2106 transmits an account inputted by the user using the input means 23 and transmits a password (hereinafter, referred to as user authentication information) associated with the account to the content distribution server 7 connected to the external network 6 through the communication I/F 22 and the wireless router 5. The user authentication information can be stored in various-type data of the storage 26. When the second and subsequent authentications are performed, the input of the authentication information can be eliminated by referring to the user authentication information stored in the various-type data. In addition, the user authentication information may be displayed in the display unit 20 by a user's operation, or may be checked by the user through a document attached at the time of purchasing the television receiver 1 or others. In addition, a MAC address of the television receiver 1 may be stored as a device ID in the storage 26 of the television receiver 1 or a non-volatile memory not illustrated.

The content distribution server 7 compares the authentication information transmitted from the television receiver 1 with the previously-registered authentication information. If the authentication information is matched, the content distribution server allows the user authenticating unit 2106 of the television receiver 1 to access. On the other hand, if the authentication information is wrong, the content distribution server 7 does not allow it to access.

The above-described configuration is an example of an authentication method, and a publicly-known technique may be used as the authentication method or the method of encrypting information transmitted/received in the authentication success, and therefore, the authentication method is not particularly limited thereto in the present embodiment.

The content reproducing unit 2107 receives the data of the content (for example, a movie, a drama, etc.) and the content information distributed from the content distribution server 7 through the external network 6, and provides the service to the user by reproducing the sequentially-received video and audio. The present embodiment has described a case of distribution and reproduction of the content by the streaming. All the data of the content can be previously acquired and accumulated from the server, and can be reproduced for the viewing after the completion of the accumulation. In this case, the content data is stored in a content 2201 of the storage 26.

In addition, information of a reproduction pause position of the content can be stored as resume information in the user management information 55 of the storage 53 of the content distribution server 7. When the same content is reproduced again by the same user, the data on the reproduction pause position is acquired from the resume information and can be used as a reproduction start position. The resume information is managed for each user with reference to the user authentication information of the television receiver 1. When all the data of the content is previously acquired from the server and reproduced for the viewing, note that the data may be stored in the various-type data of the storage 26 of the television receiver 1.

The various-application unit 2108 indicates an application downloaded from the content distribution server 7 in accordance with user's selection in addition to the applications illustrated in FIG. 2(a) such as the browser engine 2101 and the content reproducing unit 2107. Each application is activated by selection of an icon for activating the application displayed in the display unit 20 by receiving the operation of the user through the input means 23 to.

[Software Configuration of Server]

FIG. 2(b) is a diagram illustrating configurations of the memory 52 and the storage 53 in the configuration of the content distribution server 7 in FIG. 1(c). In FIG. 2(b), the storage 53 stores a user managing program 3001, a content managing program 3002, and a content distribution program 3003. These programs are developed in the memory 52 by the controlling unit 51, and achieve the functions as a user managing unit 3101, a content managing unit 3102, and a content distributing unit 3103 when being executed by the controlling unit 51. The user managing program 3001, the content managing program 3002, and the content distributing program 3003 can be previously stored in an external storage. The controlling unit 51 achieves the various functions in accordance with these programs. In order to facilitate the explanation in the following explanation, the respective functional units in the memory 52 mainly achieve the respective functions.

The user managing unit 3101 manages the user authentication information for authentication for each user, the device information for specifying the device of the user, and others. The authentication is performed for each user based on the user authentication information of the television receiver 1 or 2, and the authenticated user of the television receiver 1 or 2 is managed based on a different account. In addition, a plurality of accounts can be allocated to each television receiver 1 or 2, and besides, a dependency relation between the accounts can be designated. In addition, the user authentication information and the device information are stored in the user management information 55 and device information 56 of the storage 53, respectively.

The user managing unit 3101 acquires the user authentication information inputted through the communication I/F 50 and the external network 6 by the user of the television receiver 1 or 2 using the input means 23 and acquires the device information of the device to be used by the user, and checks whether or not the user is a regularly-registered user by inquiring into the previously-stored user authentication information, and whether or not the device of the user falls within the number of devices of the same user allowed by the service provider. The user managing unit has a function of returning the error information if the user authentication information is not correct or if the number exceeds the allowed number of the devices. In addition, the user managing unit 3101 can set different accounts (primary managers) each of which has a setting authority of the television receiver 1 or 2 connected through the external network 6 and the wireless router 5. In the present embodiment, it is assumed that the user having the setting authority of the television receiver 1 or 2 can be registered as the account (the primary manager).

The content managing unit 3102 manages the content information or the application information configured by the content or the application data and information associated with them. The content information such as a moving picture is recorded, such as a content ID for uniquely identifying the content, a content format, content explanatory information (genre, title, cast member, story, etc.), content data, a target device suitable for the size and the display of the content, a fee to be charged by the reproduction of the distribution service or the distributed content for the viewing, a viewing period, and others.

In addition, the application information is recorded, such as an application ID for uniquely identifying the application, application explanatory information, a target device suitable for the size and the display of the application, a fee to be charged by the download of the application, and others.

Note that these various types of information may be recorded by using a recording medium such as a hard disk, and be read onto the memory managed by the content managing unit 3102. In addition, for the management, the various types of information may be divided into some pieces such as the content or the application data, and data (meta data) explaining the content or the application data. Key information may be managed for decrypting and reproducing the content which is encrypted by using an RSA cryptographic technology for the protection from a malicious third party through a communication path such as the Internet. Note that these various types of information may be recorded by using a recording medium such as a hard disk, and be read onto the memory managed by the content managing unit 3102.

The content distributing unit 3103 can control the distribution of the content such as the moving picture accumulated in the content 54 of the storage 53 in accordance with a display performance of the connection device based on a distribution request from the device such as the television receiver 1 through the communication I/F 50 and the external network 6. In the present embodiment, the content 54 includes the contents having the same story and a plurality of definitions, and distributes the content in accordance with the display performance based on the device authentication information at the time of the distribution. Note that the content having only the high definition (HD) may be accumulated, and be appropriately down-converted and distributed in accordance with the display performance at the time of the distribution.

[Data Format]

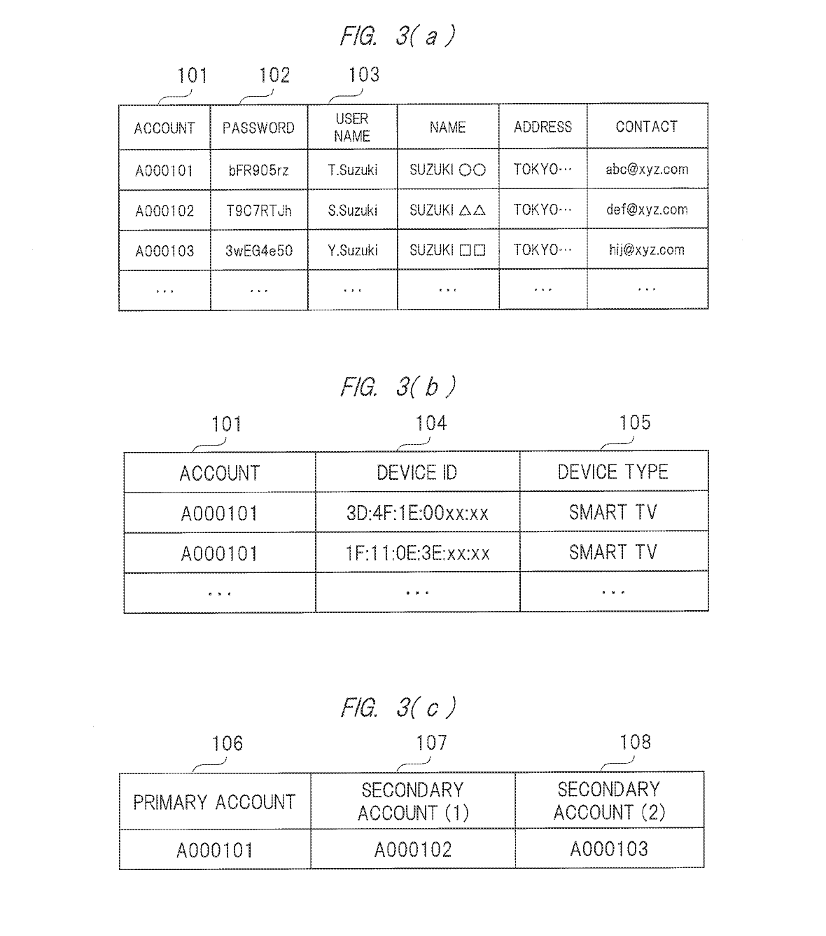

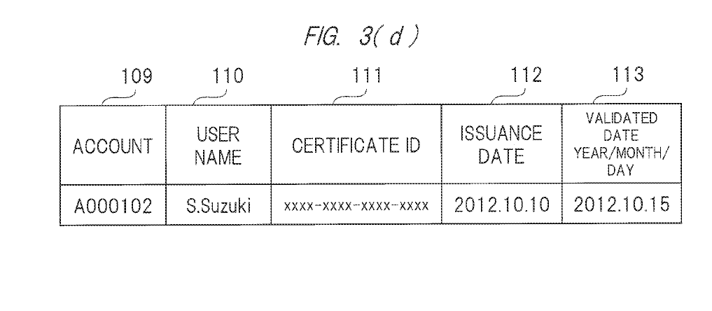

FIG. 3(a) is a data table illustrating a content example of the user management information 55 which is managed by the user managing unit 3101 of the content distribution server 7. In the user management information 55 managed by the user managing unit 3101, the account 101, a password 102, a unique user name 103, a name, an address, a contact, and others are stored. The present embodiment will be described on an assumption of the user authentication based on the password. However, a general biometric authentication such as a finger vein, a finger print, voice, a face image, or an iris, may be employed. In this case, an item of the user authentication information is appropriately changed. The user authentication information is used as login information for login from a device such as the television receiver 1 or the television receiver 2 to the content distribution service.

FIG. 3(b) is a data table illustrating a content example of the device information 56 which is managed by the user managing unit 3101 of the content distribution server 7. In the device information 56, the account 101, a device ID 104 indicating a device to be used by the user, a device type 105, and others are included, and they are the information for uniquely identifying the device, and may be previously registered in the provider of the content distribution service by the user, or may be automatically acquired by reading profile information of the device. In addition, the present embodiment shows that the user having the account 101 of “A000101” has two devices indicated by the device ID 104, and shows that the device type 105 of each device is registered as a smart television. In addition, as the device ID 104, information unique to the device such as a MAC (Media Access Control) address can be also used. Furthermore, a classification of the reproducible content type, resource information of an image processing capability, and others can be also previously accumulated as a database in association with the device ID.

FIG. 3(c) is a data table illustrating a content example of a dependency relation of the account which is managed by the content distribution server 7. The data table is configured by two hierarchical levels of a primary account 106 at the uppermost account hierarchical level, and a secondary account (1) 107 and a secondary account (2) 108 at a lower hierarchical level, and shows that the secondary account (1) 107 and the secondary account (2) 108 are in the dependency relation with respect to the primary account 106. Note that three or more secondary accounts dependent on the primary account may be registered.

FIG. 3(d) is a data table illustrating a content example of an account certificate. The account certificate indicates an example in a certification case that the user logs in by using the television receiver 1 and is authenticated by the content distribution server 7. In this case, when the content distribution service is used in the television receiver 1, the user can automatically log in by using the previously-stored account certificate. The account certificate is configured by an account 109, a user name 110, a certificate ID 111, an issuance date (year/month/day) 112 of the certificate, and a validated date 113 of the certificate, and is stored in the user management information 55 in association with the account 109 and the certificate ID 111. In addition, the account certificate is used while being encrypted by the RSA technology in order to prevent falsification or others. In addition, the login user using the primary account can also acquire the account certificate of the secondary account in the dependency relation. Here, the account certificate is called certificate information. In addition, the secondary account is called a family account.

[Initial Setting]

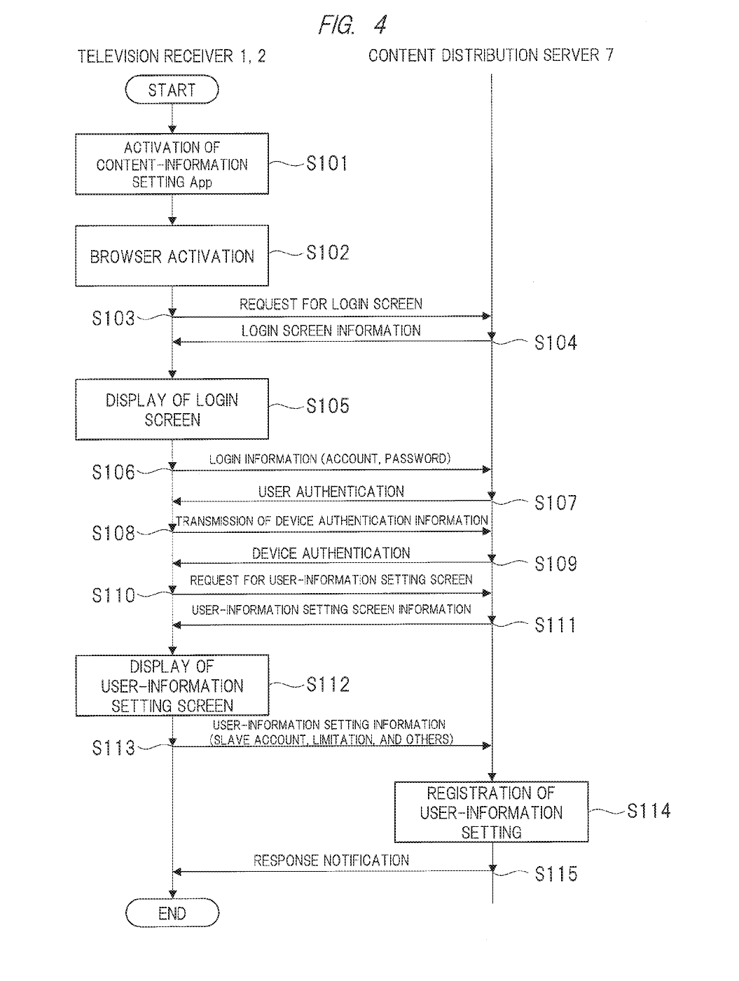

Hereinafter, an operation example at the time of an initial setting in a case that the network terminal system is firstly used will be described using FIGS. 4 to 7.

FIG. 4 is a diagram illustrating an example of an operation sequence at the time of the initial setting according to the first embodiment. FIG. 4 is a sequence diagram illustrating an operation in a case that the primary account of the television receiver 1 performs the initial setting of a dependency setting of the account in the data format illustrated in FIG. 3(c) or others on the content distribution server 7 through the input using the input means 23 of the television receiver 1. A case of the initial setting performed by the television receiver 2 is the same operation, and therefore, the description will be omitted.

FIG. 5 illustrates a display example of a menu screen of the television receiver 1.

S101: In FIG. 5, when a “user information setting” 202 of a menu screen 201 is selected by the input means 23, the controlling unit 24 of the television receiver 1 activates a “content information setting” application.

S102: Next, the controlling unit 24 of the television receiver 1 activates the browser engine 2101 in response to a command from the “content information setting” application.

S103: The browser engine 2101 accesses the content distribution server 7 linked by the previously-set link information, and requests the login screen information.

S104: The content distribution server 7 transmits the login screen information to the television receiver 1.

S105: The browser engine 2101 generates a login screen based on the received login screen information, and displays the login screen to input a user information setting screen in the display unit 20.

S106: The browser engine 2101 of the television receiver 1 transmits a character string of the user account and the password, which are inputted through the input means 23, to the content distribution server 7 as the login information.

S107: The content distribution server 7 refers to the user management information 55 by the user managing unit 3101, and authenticates the user if the user is the regularly-registered user.

S108: When the television receiver 1 is authenticated as the user by the content distribution server 7, the television receiver 1 transmits the device ID to the content distribution server 7 to uniquely identify the device to be used by the user.

S109: The content distribution server 7 refers to the device information 56 by using the user managing unit 3101, and authenticates the device if the device is the regularly-registered device or falls within the range of the allowed number of devices.

S110: The browser engine 2101 of the television receiver 1 requests user-information setting screen information from the content distribution server 7.

S111: The content distribution server 7 generates the user-information setting screen information and transmits the generated information to the television receiver 1.

S112: The browser engine 2101 of the television receiver 1 generates the user information setting screen based on the received user-information setting screen information, and displays the generated screen in the display unit 20.

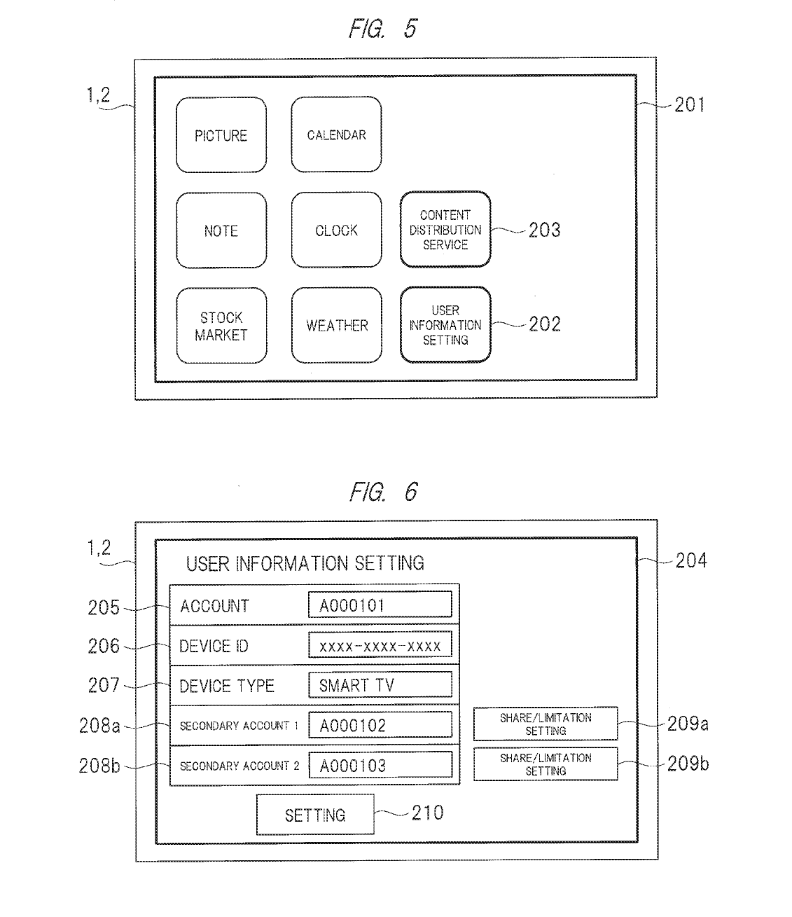

FIG. 6 illustrates a display example of a user information setting screen 204.

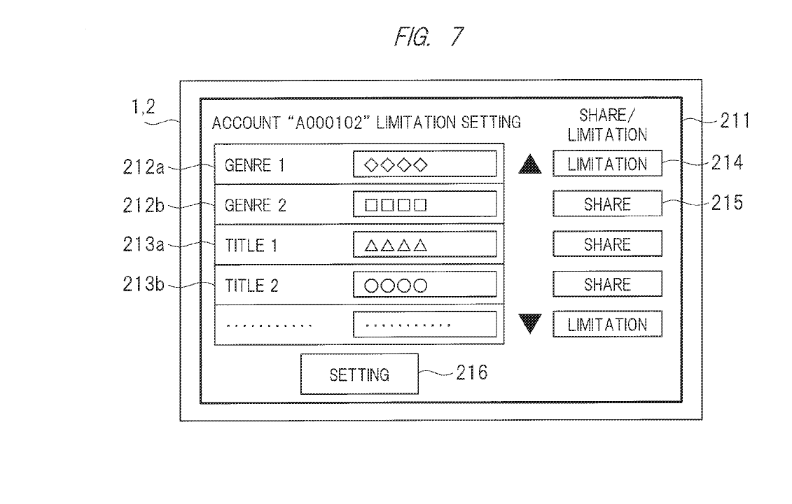

In FIG. 6, an “account” tab 205 indicates the account which is displayed with reference to the login information. A “device ID” tab 206 indicates the device ID for uniquely identifying the device such as the television receiver 1. The device ID can be checked by a label attached to the device, other menu, or others, and is inputted by the user using the input means 23. In addition, device-unique information such as a MAC (Media Access Control) address can be used as the device ID. A “device type” tab 207 displays the device type classification selected by using the input means 23 through a GUI of a pull-down form from a list not illustrated. A “secondary account 1” 208a and a “secondary account 2” 208b indicate the accounts at the hierarchical level lower than that of the primary account. In the present embodiment, two secondary accounts at the same hierarchical level can be set by using the input means 23. However, different hierarchical levels can be also set between the secondary accounts. In addition, as the secondary account, the secondary account acquired or registered by another menu, a PC, or others not illustrated is used. In order to set the shared or limited content with respect to the secondary account, “share/limitation setting” buttons 209a and 209b are indicated as buttons for the shift to another menu of FIG. 7 as described below. A “setting” button 210 indicates a button for checking the input data on the user information setting screen.

FIG. 7 illustrates a display example of a secondary-account share/limitation setting screen. In a secondary-account share/limitation setting screen 211 of FIG. 7, a share tab 215, a limitation tab 214, or others can be set for “genre”, “title”, and others related to the account “A000102” set to the secondary account 1. A “genre 1” tab 212a or a “genre 2” tab 212b indicates a genre of the content, and can set a part of the content contained in this genre or the present genre so as not to be displayed by selecting the limitation tab 214 using the input means 23 in the GUI of the pull-down form from a list not illustrated. In addition, the content contained in this genre and the present genre can be shared between the primary account and the secondary account by selecting the share tab 215. Similarly, a “title 1” tab 213a or a “title 2” tab 213b can also be set for the share and the limitation for each title.

In addition, for the limitation setting, a viewing age limitation may be specified. In this case, when the viewing age limitation is set to “11 years old” in a case of, for example, PG 12 (caution to children under 12 years old (equal to and younger than elementary school age)), even though the genre is allowed, the specification can limit the content which is viewable when the viewing age limitation information contained in the content is above PG 12. A “setting” button 216 indicates a button for determining the input data on the secondary-account share/limitation setting, and for returning to the user information setting screen.

S113: When the “setting” button 210 is selected by using the input means 23 in FIG. 6, the user information setting screen is closed, and the user-information setting information is transmitted to the content distribution server 7.

S114: When receiving the user-information setting information from the television receiver 1, the content distribution server 7 registers the user-information setting information in the user management information 55.

S115: When the registration is completed, a response notification is transmitted to the television receiver 1.

[Operation Flow/Sequence]

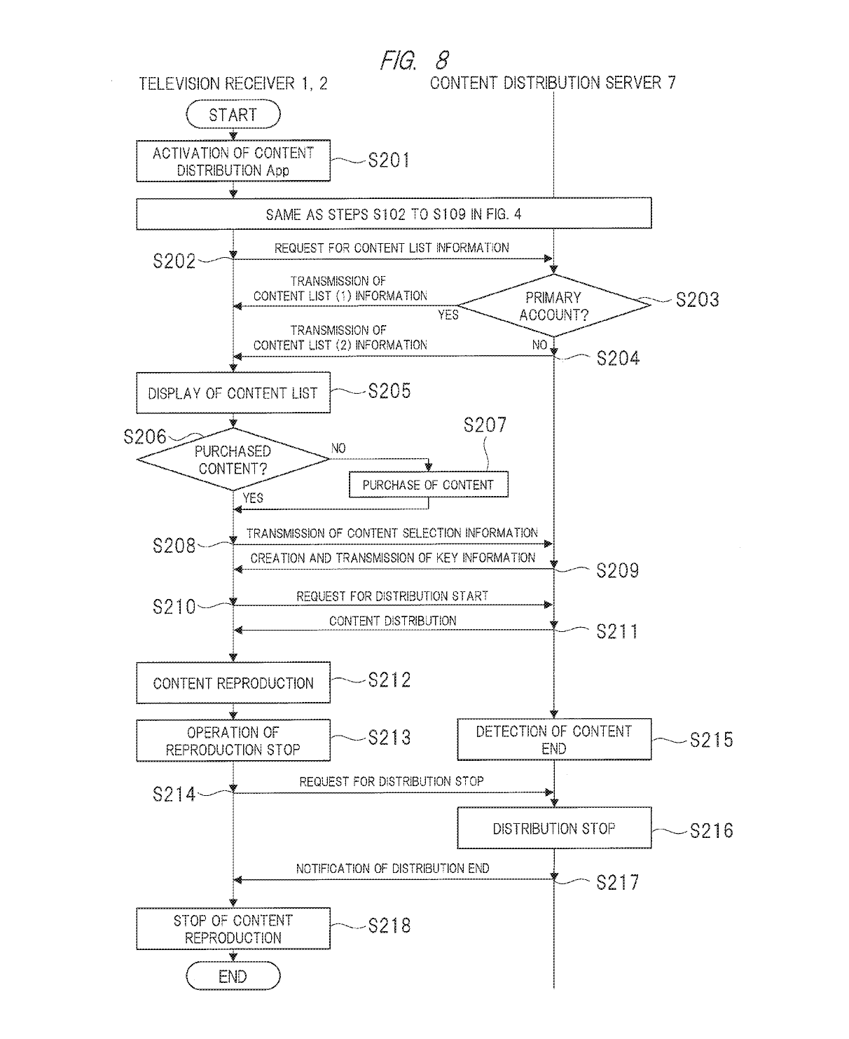

FIG. 8 is a diagram illustrating an example of an operation sequence according to the first embodiment. FIG. 8 illustrates an example in a case of viewing of the content in the television receiver 1 by the distribution of the content from the content distribution server 7 to the television receiver 1. In addition, a relation between a display example of the screen and a process will be described by using FIGS. 5 and 9 to 12.

S201: In FIG. 5, when a “content distribution service” 203 on the menu screen 201 is selected by the input means 23, the controlling unit 24 of the television receiver 1 activates the “content distribution service” application.

S102 to S109: These steps are the same as Steps S102 to S109 of FIG. 4, and therefore, the descriptions thereof will be omitted.

S202: The browser engine 2101 of the television receiver 1 requests the content list information from the content distribution server 7.

S203: The content distribution server 7 determines whether or not the account received from the television receiver 1 is the previously-registered primary account, and, if it is the primary account (S203: YES), the content distribution server transmits the original content list (1) information.

S204: If it is not the primary account (S203: NO), the content distribution server transmits the content list (2) information. The content list (2) information is the content list information which is limited in the purchased genre, title, or others the content in comparison with the original content list (1) information, and the charging information about the content purchase can be also not contained in the information.

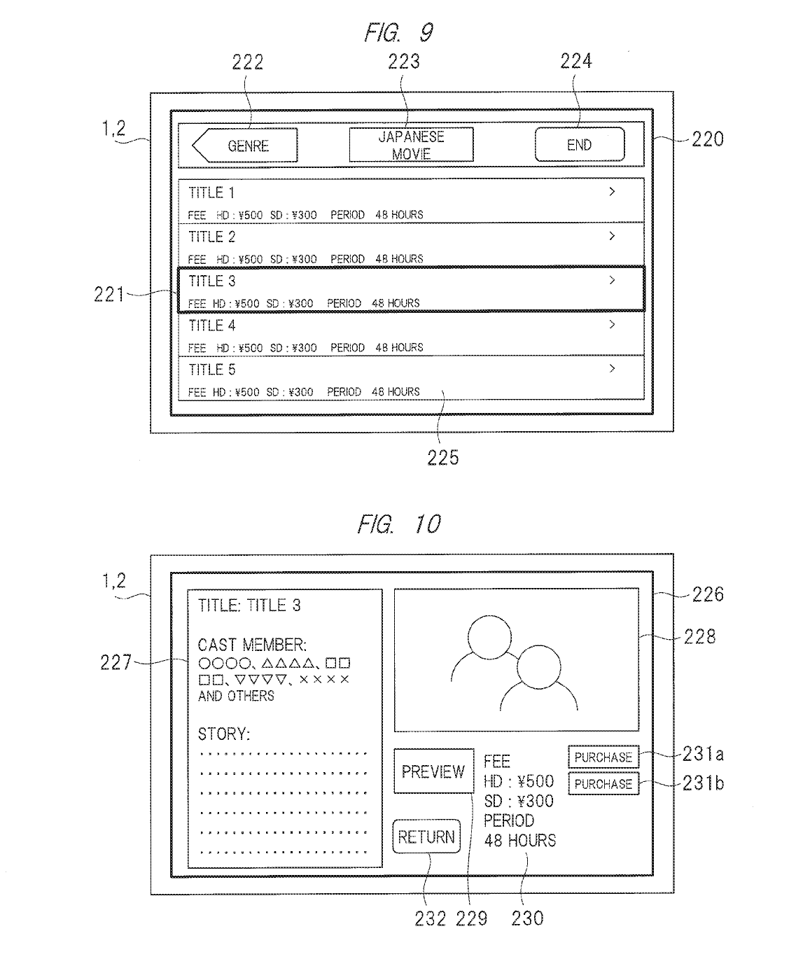

S205: The browser engine 2101 refers to the content ID for uniquely identifying the content, the content explanatory information (genre, title, cast member, story, etc.), the fee for the reproduction and viewing of the content, the viewing period, or others contained in the content list information, and displays a content list display screen illustrated in FIG. 9 or 11 on the display unit 20.

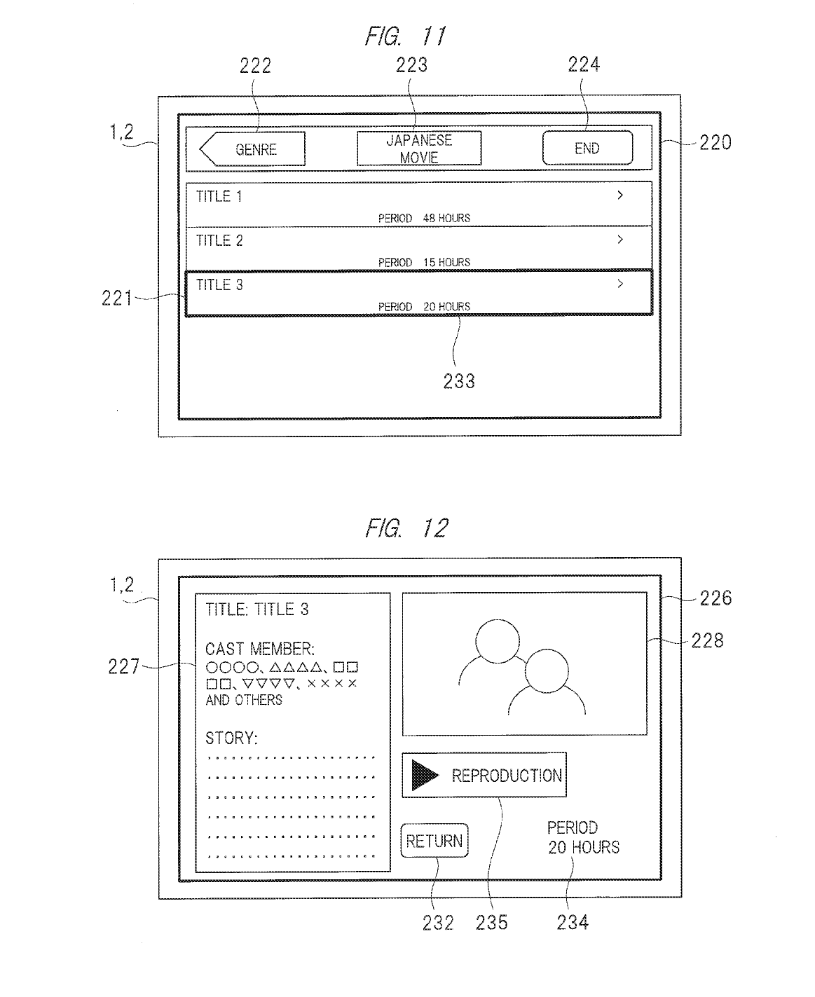

FIG. 9 illustrates a display example of the content list display screen based on the content list (1) information, and FIG. 11 illustrates a display example of the content list display screen based on the content list (2) information. In addition, FIG. 10 illustrates a display example of a content detail display screen based on the content list (1) information, and FIG. 12 illustrates a display example of the content detail display screen based on the content list (2) information.

Ina content list display screen 220 in FIG. 9, a content title name 221, a “viewing charge/viewing period” 225, and others are displayed. In addition, a “return” button 222 denoted by “genre” is a button for returning to the upper hierarchical level by the operation of the input means, and can return the screen to one previous genre hierarchical level. The example of FIG. 9 shows the selection of “Japanese movie” 223 in a movie genre. An “end” button 224 ends the display of the content list display screen 220 through the operation using the input means 23.

Next, when the content title name 221 of the content which is desired to be viewed is selected on the content list display screen through the input means 23, a content detail display screen 226 illustrated in FIG. 10 is displayed.

In FIG. 10, the title, the cast member(s), the story details, and others are displayed in a detailed content unit 227. A “preview” button 229 is a button for checking a part of the content story. An index screen 228 is a pause image showing one scene of the content, and a part of the content story can be reproduced by the “preview” button 229 on the screen. A “viewing charge/viewing period” 230 indicates a purchase charge for each definition of each content and a viewable period counted from the first reproduction after the purchase. “Purchase” buttons 231a and 231b are buttons for selecting and purchasing the content. After purchasing the content, the reproduction can be performed on the same content detail display screen as the content detail display screen based on the content list (2) information illustrated in FIG. 12. A “return” button 232 is a button for returning to the content list display screen of FIG. 9.

In FIG. 11, in comparison with FIG. 9, the title of the purchased content is displayed as the content title, and a “period” 233 is displayed for the purchased content instead of the “viewing charge/viewing period” 225. A “period” 233 indicates a left time until the viewing period is expired. In addition, in FIG. 12, in comparison with FIG. 10, a “period” 234 is displayed instead of the “viewing charge/viewing period” 230, and a “reproduction start” button 235 is displayed instead of the “preview” button 229. In addition, the “purchase” buttons 231a and 231b are not displayed.

S206: It is determined whether or not the content selected on the content list display screen 220 has been already purchased. In a case of the content list display screen based on the content list (2) information, note that only the already-purchased content is displayed, and therefore, the process is performed only on the already-purchased content (S206: YES).

S207: If the content is not the already-purchased content (S206: NO), the content can be purchased by the “purchase” buttons 231a and 231b on the screen of FIG. 10. When the content is purchased, content selection information is transmitted to the content distribution server 7 by selecting the “purchase” buttons 231a and 231b of FIG. 10. The content distribution server 7 generates information of the content purchase screen in a step not illustrated, and transmits the information to the television receiver 1. Hereinafter, the detailed description on the content purchase will be omitted.

S208: If it is the already-purchased content (S206: YES), when the “reproduction start” button 235 is selected by the input means 23 in FIG. 12, the controlling unit 24 transmits the content selection information created based on the content ID for uniquely identifying the selected content to the content distribution server 7.

S209: The content distribution server 7 generates the key information for decoding the content, and transmits the key information to the television receiver 1. The key information is configured by the content ID, the validated date (or validated times), and others for each content in addition to the decryption key. Note that Step S209 of transmitting the key information is performed when it is required to encrypt the content, and may be omitted if it is not required.

S210: The television receiver 1 receives the key information from the content distribution server 7, and transmits a distribution start request to the content distribution server 7 when the preparation for the content reception is completed.

S211: In the content distribution server 7, the content distribution is started by the content distributing unit 3103.

S212: If the decryption key is provided, the content reproducing unit 2107 of the television receiver 1 decrypts the content by using the decryption key, and then, starts the reproduction of the content.

S213: A “reproduction pause” button (not illustrated) is selected by the input means 23.

S214: When the “reproduction pause” button (not illustrated) is selected, a distribution pause request is transmitted to the content distribution server 7.

S215: The content distributing unit 3103 of the content distribution server 7 issues an instruction of the distribution pause when the end of the content is detected.

S216: When the content distribution server 7 detects the end of the content in Step S215, or a case where the distribution pause request is received from the television receiver 1 in Step S214, the distribution of the content is paused.

S217: When the distribution of the content is paused, a notification of the content distribution end is transmitted to the television receiver 1.

S218: When receiving the notification of the content distribution end, the content reproducing unit 2107 of the television receiver 1 pauses the reproduction of the content.

Here, the present embodiment has explained the case of the distribution of the content from the content distribution server to the television receiver and the viewing of the content in the television receiver. However, the embodiment can be similarly performed even in a case of viewing of a Web content. In this case, a “limitation” setting, a “share” setting, or others may be performed on a URL (Uniform Resource Locator) to be limited or shared instead of the title, the genre, and others of the content. In addition, in the case of the “limitation” setting, a Web filtering function may be effective.

As described above, when the television receiver or others is shared among a plurality of users, a user having the secondary account (the family account) in the dependency relation of the primary account can view the content from the content list display screen which is limited in the genre, the title, the URL, or others in the already-purchased content, so that the safe and simple operation while protecting the privacy of each user is possible.

### Second Embodiment

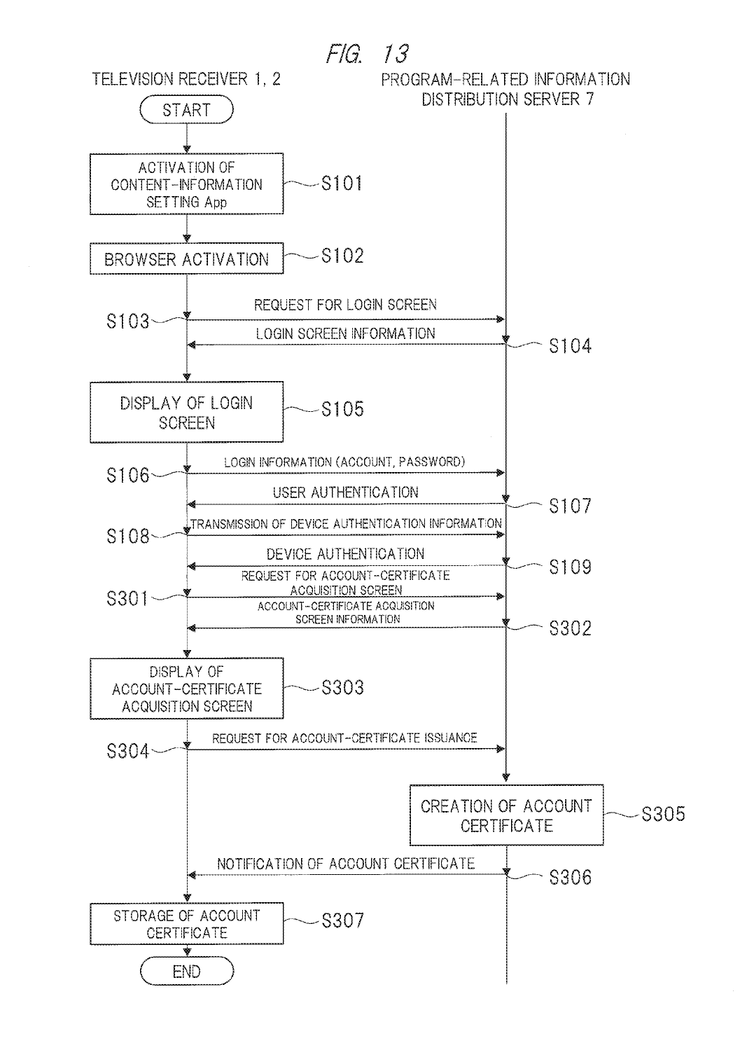

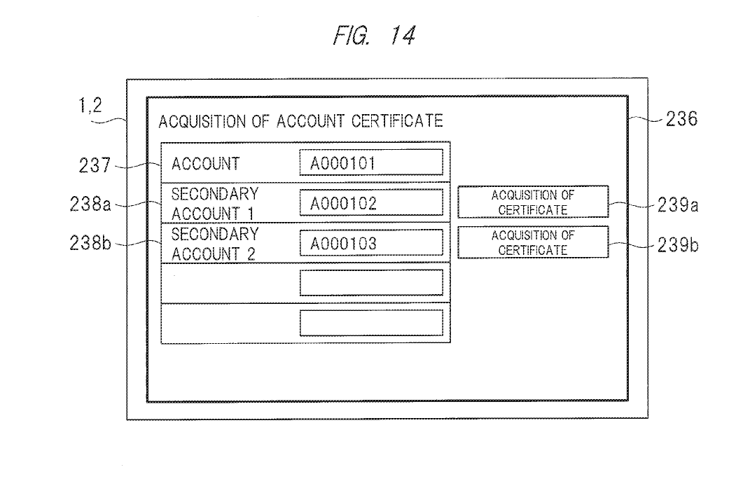

Hereinafter, a second embodiment according to the present invention will be described by using FIGS. 13 and 14. In addition, in comparison with the first embodiment, differences will be described while being highlighted. The system configuration, the hardware configuration, and the software configuration have the same operations as those of the first embodiment, and therefore, the descriptions thereof will be omitted.

[Initial Setting]

FIG. 13 is a diagram illustrating an example of an operation sequence at the time of an initial setting according to the second embodiment. FIG. 13 is a sequence diagram illustrating an operation in a case that the user of the primary account of the television receiver 1 acquires an account certificate for facilitating the login based on a slave account to the content distribution server 7 by the input using the input means 23 of the television receiver 1. The case of the initial setting by the television receiver 2 is the same as above, and therefore, the description thereof will be omitted. In addition, a display example of the screen and a processing relation will be described by using FIG. 14.

The processes of Steps S301 to S307 instead of Steps S110 to S115 are added to FIG. 4 of the first embodiment.

S101 to S109: These steps are the same as those of FIG. 4, and therefore, the description thereof will be omitted.

S301: The browser engine 2101 of the television receiver 1 requests account certificate acquisition screen information from the content distribution server 7.

S302: The content distribution server 7 generates the account certificate acquisition screen information, and transmits the account certificate acquisition screen information to the television receiver 1.

S303: The browser engine 2101 of the television receiver 1 generates an account certificate acquisition screen based on the received account certificate acquisition screen information, and displays the screen on the display unit 20.

FIG. 14 illustrates a display example of an account certificate acquisition screen 236.

In FIG. 14, the “account” tab 237 indicates the primary account which is logged in. “Secondary account” tabs 238a and 238b indicate the secondary accounts set in FIG. 6. By the “secondary account” tabs 238a and 238b, the issuance of the certificate can be requested through the selection of the “certificate acquisition” buttons 239a and 239b by using the input means 23. When the user information setting is registered in Step S114 of FIG. 4, the account certificate of the secondary account which is the slave account can be acquired.

S304: When the “certificate acquisition” button 239a or 239b is selected by using the input means 23 in FIG. 14, the content distribution server 7 is requested to issue the account certificate.

S305: The content distribution server 7 generates the account certificate stored in the user management information 55 in the form of FIG. 3(d).

S306: The content distribution server 7 notifies the television receiver 1 of the generated account certificate.

S307: The television receiver 1 stores the acquired account certificate in the various pieces of data of the storage.

[Operation Flow/Sequence]

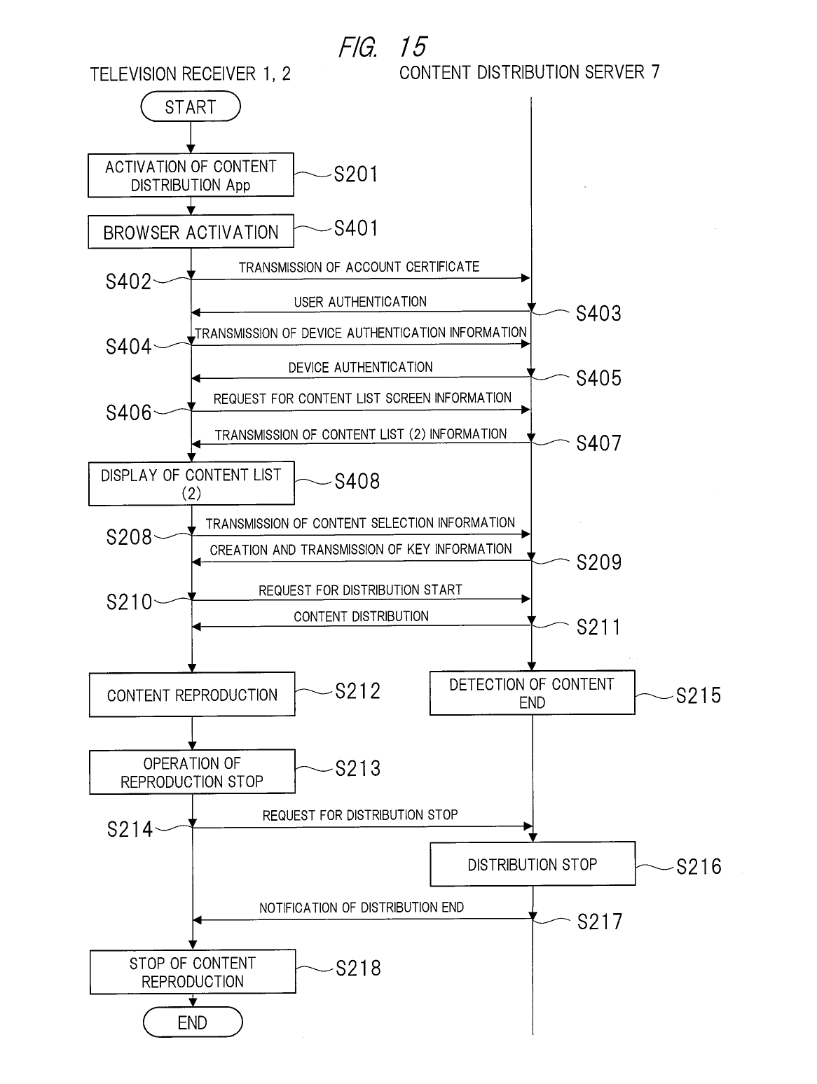

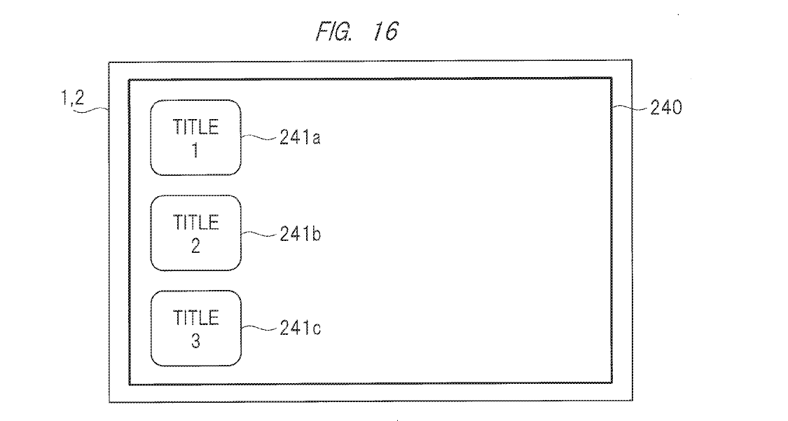

FIG. 15 is a diagram illustrating an example of an operation sequence according to the second embodiment. FIG. 15 illustrates an example in a case of viewing of the content in the television receiver 1 by the distribution of the content from the content distribution server 7 to the television receiver 1. In addition, a relation between a display example of the screen and a process will be described by using FIGS. 5 and 16.

Instead of Steps S102 to S109 (the same as those of FIG. 4) and Steps S202 to S207, the processes of Steps S401 to S408 are added to FIG. 8 of the first embodiment.

S201: In FIG. 5, when a “content distribution service” 203 on the menu screen 201 is selected by the input means 23, the controlling unit 24 of the television receiver 1 activates the “content distribution service” application.

S401: Next, the controlling unit 24 of the television receiver 1 activates the browser engine 2101 in response to a command from the “content distribution service” application.

S402: When the account certificate exists, the browser engine 2101 transmits the account certificate to the content distribution server 7 in priority to a login screen request. Note that the account certificate can be also temporarily invalidated by a setting using a menu not illustrated or others. In this case, the normal login screen described in FIG. 4 or 8 is displayed, so that the operation based on the user authentication information can be also achieved. In addition, when a plurality of services are used, the account certificate of a using service may be selected by the pull-down type GUI from an account certificate list.

S403: The content distribution server 7 refers to the user authentication information registered in the user management information 55 based on the user authentication information of the received account certificate, and, if the user is a regularly-registered user, the content distribution server 7 authenticates the user.

S404: When the television receiver 1 receives the user authentication from the content distribution server 7, the television receiver 1 transmits the device ID used for uniquely identifying the device to be used by the user to the content distribution server 7.

S405: the content distribution server 7 refers to the device information 56 by using the user managing unit 3101, and, if the device is the regularly-registered device or is within the range of the allowed number of devices, the content distribution server 7 authenticates the device.

S406: The browser engine 2101 of the television receiver 1 requests the content list information from the content distribution server 7.

S407: Since the account of the account certificate received from the television receiver 1 is the secondary account in the dependency relation with respect to the previously-registered primary account, the content distribution server 7 transmits the content list (2) information as similar to the process of Step S203: NO illustrated in FIG. 8.

S408: The browser engine 2101 refers to the content ID used for uniquely identifying the content, the content explanatory information (genre, title, cast member, story, etc.), and/or others contained in the content list information, and displays the content list display screen as illustrated in FIG. 16 in the display unit 20.

FIG. 16 illustrates a display example of the content list display screen based on the content list (2) information.

In a content list display screen 240 of FIG. 16, titles 241a, 241b, and 241c indicate contents among the contents purchased by the primary account or free contents, the contents having the “share” setting to the secondary account indicated by the account certificate in FIG. 7 or a content having the “limitation” setting thereto, and the screen is the content list display screen more simplified than FIG. 9 or 11. The titles 241a, 241b, and 241c may be displayed by using objects such as graphical icons. In addition, a still image indicating a part of the content or others can be also displayed as the object.

S208 to S218: The processes are the same as those of FIG. 8, and therefore, the descriptions thereof will be omitted.

Here, as similar to the first embodiment, these processes can be performed in a case of viewing of the Web content.

As described above, the input required for the login can be eliminated by using the certificate information of the account certificate, and therefore, the user having the secondary account (the family account) with the dependency relation can view the content only by a simple operation. In addition, the service provider can safely provide the content distribution service.

Note that the present invention is not limited to the above-described embodiments, and includes various modifications. For example, in the above-described embodiments, the entire system has been described in detail in order to understandably explain the present invention, and therefore, the embodiments are not always limited to the one having all the described configurations. In addition, a part of the configuration of one embodiment can be replaced with the configuration of the other embodiment, and the configuration of the other embodiment can be added to the configuration of the one embodiment. In addition, other configuration can be added to/eliminated from/replaced with a part of the configuration of each embodiment.

In addition, apart or entire of each configuration, function, processing unit, and others described above may be achieved by, for example, hardware through design in an integrated circuit or others. In addition, each configuration, function, and others described above may be achieved by software through interpretation and execution of a program for achieving each function by a processor. The information of the program for achieving each function, the table, the file, and others may be stored in a recording device such as a memory, a hard disk, and an SSD (Solid State Drive), or a recording medium such as an IC card, and an SD card, and a DVD.

In addition, the control lines and the information lines considered as necessary for the explanation are illustrated, and therefore, all the control lines and the information lines are not necessarily illustrated in term of a product. Practically, it may be considered that almost all the configurations are connected to each other.

In addition, in the above-described embodiments, the embodiments have been described by using the television receiver 1 and the television receiver 2 having the display unit 20. However, the present invention can be similarly performed by a STB (set-top box), a recorder, or others which is provided with an external display unit. In addition, the present embodiments may be similarly performed by a PC having a communication I/F, a monitor device, a tablet terminal, or others.

### REFERENCE SIGNS LIST

1 . . . television receiver, 2 . . . television receiver, 5 . . . wireless router, 6 . . . external network, 7 . . . content distribution server, 8 . . . broadcasting station, 12 . . . tuner/demodulating unit, 13 . . . channel selection controlling unit, 14 . . . demultiplexer, 15 . . . audio decoding unit, 16 . . . speaker, 17 . . . audio outputting unit, 18 . . . video decoding unit, 19 . . . superimposing unit, 20 . . . display unit, 21 . . . video outputting unit, 22 . . . communication I/F, 23 . . . input means, 24 . . . controlling unit, 25 . . . memory, 26 . . . storage, 27 . . . digital I/F, 50 . . . communication I/F, 51 . . . controlling unit, 52 . . . memory, 53 . . . storage

1. A display device which can communicate with a content distribution device through a network, comprising:
a user authenticating unit which manages accounts of a plurality of users and which creates user authentication information containing at least one of the plurality of accounts to be authenticated by the content distribution device;
a communicating unit which transmits the user authentication information and content selection information to the content distribution device and which receives content information from the content distribution device, the content information containing content identification information by which a content specified based on the account contained in the user authentication information can be uniquely identified;
a display unit which displays the content information received by the communicating unit; and
a selection operating unit which selects at least one content based on the content information and which creates the content selection information based on the content identification information of the selected content.

2. The display device according to claim 1,
wherein the content information is first content information which is provided to a first account of the plurality of accounts by the content distribution device, or second content information which is provided to a second account at an account hierarchical level lower than the first account, and
the display unit separately displays the first content information or the second content information.

3. The display device according to claim 2,
wherein the second content information is content information in which the content identification information contained is limited more than the first content information.

4. The display device according to claim 2,
wherein the second content information is content information which shares at least a part of the first content information.

5. The display device according to claim 2,
wherein the second account is set by the first account allowed by an account managing unit included in the content distribution device.

6. The display device according to claim 2,
wherein the communicating unit receives certificate information from the content distribution device, the certificate information indicating that the second account issued by the content distribution device is authenticated, and transmits the certificate information to the content distribution device at time of login,
the display unit displays an object associated with the certificate information and the content identification information,
the selection operating unit receives selection of the object, and,
when the selection operating unit receives the selection of the object displayed in the display unit, the second account is authenticated by a login processing unit included in the content distribution device.

7. A display device which can communicate with a content distribution device through a network, comprising:
a user authenticating unit which manages accounts of a plurality of users and which stores certificate information indicating that a second account set by a first account of the plurality of accounts and depended on the first account is authenticated by the content distribution device;
a communicating unit which transmits the certificate information and content selection information to the content distribution device and which receives content information from the content distribution device, the content information containing content identification information by which a content specified based on the account contained in the certificate information can be uniquely identified;
a display unit which displays the content information received by the communicating unit; and
a selection operating unit which selects at least one content based on the content information and which creates the content selection information based on the content identification information of the selected content.

8. A content viewing system comprising:
a display device; and
a content distribution device,
wherein the display device includes:
a user authenticating unit which manages accounts of a plurality of users and which creates user authentication information containing at least one of the plurality of accounts to be authenticated by the content distribution device;
a first communicating unit which transmits the user authentication information and content selection information to the content distribution device and which receives content information from the content distribution device;
a display unit which displays the content information received by the first communicating unit; and
a selection operating unit which selects at least one content based on the content information and which creates the content selection information based on the content identification information of the selected content, and
the content distribution device includes:
a second communicating unit which receives the user authentication information and the content selection information from the display device and which transmits the content information to the display device, the content information containing the content identification information by which a content specified based on the account contained in the user authentication information can be uniquely identified; and
a login processing unit which authenticates the account contained in the user authentication information.

9. The content viewing system according to claim 8,
wherein the content information is first content information which is provided to a first account of the plurality of accounts by the content distribution device, or second content information which is provided to a second account at an account hierarchical level lower than the first account, and
the display unit separately displays the first content information or the second content information.

10. The content viewing system according to claim 8,
wherein the second content information is content information in which the content identification information contained is limited more than the first content information.

11. The content viewing system according to claim 8,
wherein the second content information is content information which shares at least a part of the first content information.

12. The content viewing system according to claim 8,
wherein the content distribution device includes an account managing unit which allows the first account to set the second account.

13. The content viewing system according to claim 8,
wherein the second communicating unit transmits certificate information issued for indicating that the content distribution device authenticates the second account, and receives the certificate information from the display unit at time of login,
the first communicating unit receives the certificate information from the content distribution device, and transmits the certificate information to the content distribution device at time of login,
the display unit displays an object associated with the certificate information and the content identification information,
the selection operating unit receives selection of the object,
when the selection operating unit receives the selection of the object displayed in the display unit, the first communicating unit transmits the content identification information corresponding to the certificate information and the object, and
a login processing unit authenticates the second account based on the certificate information.

14. A content viewing system comprising:
a display device; and
a content distribution device,
wherein the display device includes:
a user authenticating unit which manages accounts of a plurality of users and which stores certificate information indicating that a second account set by a first account of the plurality of accounts and depended on the first account is authenticated by the content distribution device;
a first communicating unit which transmits the certificate information and content selection information to the content distribution device and which receives content information from the content distribution device;
a display unit which displays the content information received by the first communicating unit; and
a selection operating unit which selects at least one content based on the content information and which creates the content selection information based on the content identification information of the selected content, and
the content distribution device includes:
a second communicating unit which receives the certificate information and the content selection information from the display device and which transmits the content information to the display device, the content information containing the content identification information by which a content specified based on the account contained in the certificate information can be uniquely identified; and
a login processing unit which authenticates the account contained in the certificate information.
